(19) United States
(12) Patent Application Publication
(10) Pub. No.: US 2025/0260579 A1
(43) Pub. Date: Aug. 14, 2025

(54) PERSONAL INTERNET OF THINGS NETWORK MANAGEMENT METHOD AND SYSTEM

(71) Applicant: Samsung Electronics Co., Ltd., Gyeonggi-do (KR)

(72) Inventors: Arunprasath RAMAMOORTHY, Bangalore (IN); Basavaraj Jayawant PATTAN, Bangalore (IN); Sapan Pramodkumar SHAH, Bangalore (IN)

(21) Appl. No.: 18/856,358

(22) PCT Filed: Apr. 13, 2023
(86) PCT No.: PCT/KR2023/005015

§ 371 Date: Oct. 11, 2024

(30) Foreign Application Priority Data
Apr. 13, 2022 (IN) 202241022235
Apr. 5, 2023 (IN) 202241022235

(51) Int. Cl. H04L 9/32

(52) U.S. Cl. CPC H04L 9/3226

(57) ABSTRACT

The disclosure relates to a 5G or 6G communication system for supporting a higher data transmission rate. Embodiments herein disclose Personal Internet of Things (IoT) Network (PIN) management method. The method includes creating, by a PIN entity, at least one of a PIN Element (PINE) profile and a PIN profile comprising PIN information. Further, the method includes storing, by the PIN entity, at least one of the PIN element profile and the PIN profile at the PIN entity. Further, the method includes accessing, by the PIN entity, at least one of the PIN element profile and the PIN profile. In an embodiment, the method includes performing, by the PIN entity, at least one of: activating a PIN, deactivating the PIN, updating PIN dynamic information, and managing the PIN profile. The PIN entity can be, for example, but not limited to the PEMC entity (200), the PEGC entity (300) and the PIN management server (100).

### TECHNICAL FIELD

The disclosure relates generally to wireless communication networks and more specifically, the disclosure relates to manage a Personal IoT Network (PIN) and PIN elements (PINE) profiles in the PIN.

### BACKGROUND ART

5G mobile communication technologies define broad frequency bands such that high transmission rates and new services are possible, and can be implemented not only in “Sub 6 GHZ” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide methods and systems for managing PIN profiles, PIN element profiles and PIN context/dynamic profile information in PINs.

### Solution to Problem

Accordingly, the embodiments herein provide a Personal Internet of Things (IoT) Network (PIN) management method. The method includes creating, by a PIN entity, at least one of a PIN Element (PINE) profile and a PIN profile comprising PIN information. Further, the method includes storing, by the PIN entity, at least one of the PIN element profile and the PIN profile at the PIN entity. Further, the method includes accessing, by the PIN entity, at least one of the PIN element profile and the PIN profile. In an embodiment, the method includes performing, by the PIN entity, at least one of: activating a PIN, deactivating the PIN, updating PIN dynamic information, and managing the PIN profile.

In an embodiment, activating the PIN includes receiving, by a PIN management server, a request message from a first PINE from a plurality of PINEs for registering to the PIN as a PIN Element with Management Capability (PEMC) entity, authenticating and authorizing, by the PIN management server, the first PINE as the PEMC entity based on the PIN profile, sending, by the PIN management server, a response message to the first PINE, where the response message indicates that the first PINE is authorized as the PEMC entity, receiving, by the PIN management server, an activation request message from the first PINE for activating the PIN based on the response message, requesting, by the PIN management server, a fifth generation core (5GC) entity to activate the PIN based on the activation request message, sending, by the PIN management server, a PIN activation success response to the first PINE, and updating, by the PIN management server, the PIN dynamic information.

In an embodiment, the request message includes at least one of a PIN identifier (ID) and a PIN element ID.

In an embodiment, the activation request message includes at least one of the PIN ID, the PIN element ID, the PINAPP ID associated with the first PINE, and a duration of the PIN to be in an active state.

In an embodiment, the PIN dynamic information includes a PIN state associated with the first PINE, a PIN validity duration associated with the first PINE, the PIN element ID associated with the first PINE and the PINAPP ID associated with the first PINE.

In an embodiment, updating the PIN dynamic information includes updating and maintaining, by the PIN management server and the PEMC entity, the PIN dynamic information, receiving, by the PIN management server, a request message from a second PINE from the plurality of PINEs for registering to the PIN as a PEGC entity, where the request message includes a PIN ID, a PIN element, a PIN APP ID associated with the second PINE and a validity duration associated with the second PINE, authenticating and authorizing, by the PIN management server, the second PINE as the PEMC entity based on the PIN profile, sending, by the PIN management server, a response message to the second PINE, where the response message indicates that the second PINE is authorized as the PEGC entity, updating, by the PIN management server, the PIN dynamic information associated with information associated with the PEGC entity, where the information comprises at least one of the PINAPP ID, a PIN element ID, a reachability information, and a validity duration associated with the PEGC entity, and notifying, by the PIN management server, the information associated with the PEGC entity to the PEMC entity.

In an embodiment, the method includes updating, by the PEMC entity, the PIN dynamic information associated with the information. Further, the method includes receiving, by the PEMC entity, at least one of a register request, a join request, an attach request from a third PINE from the plurality of PINEs to join with the PIN. Further, the method includes authorizing, by the PEMC entity, the third PINE. Further, the method includes updating, by the PEMC entity, the PIN dynamic information associated with the third PINE. Further, the method includes receiving, by the PEMC entity, a notification comprising PIN elements details from the PIN management server. Further, the method includes notifying, by the PEMC entity, an information to the PIN management server, where the information comprises at least one of joining the PINE, leaving the PINE and capability change of the PIN entity.

In an embodiment, the PIN dynamic information is updated, when at least one of:
a) the PIN is activated by the PIN management server based on a request message from at least one of the PEMC entity and an authorized user,
b) the PIN management server updates the PIN dynamic information while registering the PEMC entity or the PEGC entity,
c) the PEMC entity updates the PIN dynamic information and notifies the PIN management server for updating the PIN dynamic information when one of the PIN element joins the PIN or the PIN element leaves the PIN,
d) the PIN element is detected to be unavailable or not reachable,
c) a role of the PEMC entity is changed,
f) the capabilities or service offered by the PIN or PIN elements changes
g) a role of the PEGC entity is changed, and
h) the PIN is deactivated.

In an embodiment, deactivating the PIN includes receiving, by the PIN management server, a request message from a first PINE from a plurality of PINEs for deactivating the PIN, authorizing, by the PIN management server, the first PINE as the PEMC entity based on the PIN profile, sending, by the PIN management server, a response message to the first PINE, where the response message indicates the de-activating the PIN, notifying, by the PIN management server, that the PIN is being de-activated, where the PEMC entity notifies the plurality of PINEs about the deactivation of the PIN, receiving, by the PIN management server, a response to the deactivation notification message from the PEMC entity, and sending, by the PIN management server, a request message to a 5GC entity to deactivate the PIN and clean the PIN dynamic information.

In an embodiment, deactivating the PIN includes receiving, by the PIN management server, a request message from a first PINE from a plurality of PINEs for deactivating the PIN, authorizing, by the PIN management server, the first PINE as the PEMC entity based on the PIN profile, sending, by the PIN management server, a response message to the first PINE, where the response message indicates the de-activating the PIN, notifying, by the PIN management server, that the PIN is being de-activated to the PEGC entity, where the PEGC entity notifies the plurality of PINEs about the deactivation of the PIN, receiving, by the PIN management server, a response to the deactivation notification message from the PEGC entity, and sending, by the PIN management server, a request message to a 5GC entity to deactivate the PIN and clean the PIN dynamic information.

In an embodiment, managing the PIN profile includes receiving, by the PIN management server, a PIN profile management request from an user associated with the first PINE, determining, by the PIN management server, whether the user is authorized to perform the requested operation, where the determination is based on a local configuration present at the PIN management server, sending, by the PIN management server, a response to the authorized user as success after completing a requested operation or failure with a failure reason, and notifying, by the PIN management server, a PINE from the plurality of PINEs about the changes corresponding to create the PIN element profile, create the PIN profile, modify the PIN profile, modify the PIN element profile, delete the PIN element profile, and delete the PIN profile.

In an embodiment, the PIN profile management request includes at least one of a request to create the PIN element profile, a request to create the PIN profile, a request to modify the PIN profile, a request to modify the PIN element profile, a request to delete the PIN element profile, a request to delete the PIN profile

In an embodiment, the PIN profile includes at least one of a PIN identifier, a PIN name, a maximum number of a PIN element that is configured within the PIN, a list of the PIN element, a life time of the PIN element to be associated with the PIN, a service offered by the PIN, a list of PIN elements that act as a PEGC entity, a list of PIN elements comprising a validity duration, a list of PIN elements that act as PEMC entity, the list of PIN elements comprising a validity duration, a list of PIN elements that act as a relay, a life span of the PIN, a time period of the PIN when the PIN is active, and a geographical area where the PIN is active.

In an embodiment, the PIN element profile includes at least one of a PIN element identifier, a list of PIN determine whether the PIN element is authorized to join, services offered by the PIN element, whether the PIN element is authorized to act as at least one of a PEGC entity, a PEMC entity, a relay entity, accessibility of a list of services in the PIN, a list of PIN elements act as a relay, list of PIN elements it can communicate with, determination about whether the PIN element use the PEGC entity to communicate with a 5GC entity, a connection type, a discoverable option, and duration of the PIN element when the PIN element is active or associated with the PIN.

In an embodiment, the PIN entity includes at least one of a PEMC entity, a PEGC entity and a PIN management server.

Accordingly, the embodiments herein provide PIN management system comprises a PIN entity. The PIN entity is configured to create at least one of a PIN element profile and a PIN profile comprising PIN information. Further, the PIN entity is configured to store at least one of the PIN element profile and the PIN profile at the PIN entity. Further, the PIN entity is configured to access at least one of the PIN element profile and the PIN profile.

In an embodiment, the PIN entity is configured to perform at least one of activate a PIN, deactivate the PIN, update PIN dynamic information, and manage the PIN profile.

Accordingly, the embodiments herein provide a PIN management server includes a PIN management controller coupled to a processor and a memory. The PIN management controller is configured to receive a request message from a first PINE from a plurality of PINEs for registering to the PIN as a PEMC entity. Further, the PIN management controller is configured to authenticate and authorize the first PINE as the PEMC entity based on the PIN profile. Further, the PIN management controller is configured to send a response message to the first PINE, where the response message indicates that the first PINE is authorized as the PEMC entity. Further, the PIN management controller is configured to receive an activation request message from the first PINE for activating the PIN based on the response message. Further, the PIN management controller is configured to request a 5GC entity to activate the PIN based on the activation request message. Further, the PIN management controller is configured to send a PIN activation success response to the first PINE. Further, the PIN management controller is configured to update the PIN dynamic information.

In some cases, the PIN management server can activate the PIN and notify the corresponding PIN entities. In another embodiment, the PEGC entity can also activate the PIN by sending the PIN activate request to the PIN server. In another embodiment, an authorized user can request to activate the PIN from outside the PIN by sending the PIN activate request to the PIN management server. Similarly, the PIN can also be deactivated by the above PIN entities.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The disclosure may provide methods and systems for managing PIN profiles, PIN element profiles and PIN context/dynamic profile information in PINs.

The disclosure may provide methods and systems to activate the PINs.

The disclosure may provide methods and systems to update a dynamic information of the PIN.

The disclosure may provide methods and systems to de-activate the PINs by a PEMC entity.

The disclosure may provide methods and systems to de-activate the PINs by a PIN management server (PIN MS).

The disclosure may provide methods and systems to manage the PINs profiles by one or more authorized user in a wireless communication networks (e.g., PIN, an edge network, a fifth generation (5G) network, a sixth generation (6G) network or the like).

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a sequence diagram of a process of PIN activation, according to an embodiment of the disclosure;

FIG. 2 illustrates a sequence diagram of a process for updating the PIN dynamic information, according to an embodiment of the disclosure;

FIG. 3 illustrates a sequence diagram of a process of deactivating the PIN by a PEMC entity, according to an embodiment of the disclosure;

FIG. 4 illustrates a sequence diagram of a process of deactivating the PIN by the PEMC entity, according to an embodiment of the disclosure;

FIG. 5 illustrates a sequence diagram of a process of deactivating the PIN by a PIN MS, according to an embodiment of the disclosure;

FIG. 6 illustrates a sequence diagram of a process of performing PIN profile management by an authorized user, according to an embodiment of the disclosure;

FIG. 7 illustrates a sequence diagram of a process for the PIN management, according to an embodiment of the disclosure;

FIG. 8 illustrates various hardware components of the PIN management server, according to an embodiment of the disclosure;

FIG. 9 is a flow chart illustrating a PIN management method, according to an embodiment of the disclosure;

FIG. 10 is a flow chart illustrating a method for activating the PIN in accordance with the FIG. 9, according to an embodiment of the disclosure;

FIG. 11 is a flow chart illustrating a method for updating the PIN dynamic information in accordance with the FIG. 9, according to an embodiment of the disclosure;

FIG. 12 is a flow chart illustrating a method for deactivating the PIN in accordance with the FIG. 9, according to an embodiment of the disclosure;

FIG. 13 is a flow chart illustrating a method for deactivating the PIN in accordance with the FIG. 9, according to an embodiment of the disclosure; and

FIG. 14 is a flow chart illustrating a method for managing the PIN profile in accordance with the FIG. 9, according to an embodiment of the disclosure.

FIG. 15 illustrates an electronic device according to an embodiment of the disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

A Personal IoT Network (PIN) comprises of PIN Elements that communicate using PIN direct Connection or direct network connection and is managed locally (using a PIN Element with Management Capability) (i.e., PEMC entity). The PIN Element with Management Capability is a PIN element that provides a means for an authorized administrator to configure and manage the PIN. There is a need to maintain the configuration information about the PIN for managing it. Current solutions studied as part of 3GPP 23.700-78 do not take into account the need of the PIN and PIN entities related information which are required for the effective management of the PIN. In other words, current methods and systems do not have any proper mechanism for managing a PIN profile, a PIN element profile and a PIN context/dynamic profile information in the PIN. Hence, there is a need for providing methods and systems for managing the PIN profile, the PIN element profile and the PIN context/dynamic profile information in the PIN.

It is desired to address the above mentioned disadvantages or other short comings or at least provide a useful alternative.

If the PIN, the PIN entities related information, and the configuration information of the PIN are maintained, it is easy to manage the PIN. The owner of the PIN do not have to configure the PIN related information every time while activating the PIN. It is easy for the authorized user or the PIN owner to change the configuration information of the PIN. During a role change of the PEMC entity or the PEGC entity, it is required of the new PIN elements taking the role of the PEMC entity and the PEGC entity to obtain the PIN dynamic information so that they can continue managing the PIN.

The embodiments herein achieve PIN management method. The method includes creating, by a PIN entity, at least one of a PINE profile and a PIN profile comprising PIN information. Further, the method includes storing, by the PIN entity, at least one of the PIN element profile and the PIN profile at the PIN entity. Further, the method includes accessing, by the PIN entity, at least one of the PIN element profile and the PIN profile. In an embodiment, the method includes performing, by the PIN entity, at least one of: activating a PIN, deactivating the PIN, updating PIN dynamic information, and managing the PIN profile.

If the PIN, the PIN entities related information, and the configuration information of the PIN are maintained, it is easy to manage the PIN. The owner of the PIN do not have to configure the PIN related information every time while activating the PIN. It is easy for the authorized user or the PIN owner to change the configuration information of the PIN. During role change of the PEMC entity or the PEGC entity, it is required of the new PIN elements taking the role of the PEMC entity and the PEGC entity to obtain the PIN dynamic information so that they can continue managing the PIN.

In an embodiment, the PIN Management server can activate the PIN and notify the corresponding PIN entities. In another embodiment, the PEGC entity can also activate the PIN by sending the PIN activate request to the PIN server. In another embodiment, an authorized user can request to activate the PIN from outside the PIN by sending the PIN activate request to the PIN management server. Similarly, the PIN can also be deactivated by the above PIN entities.

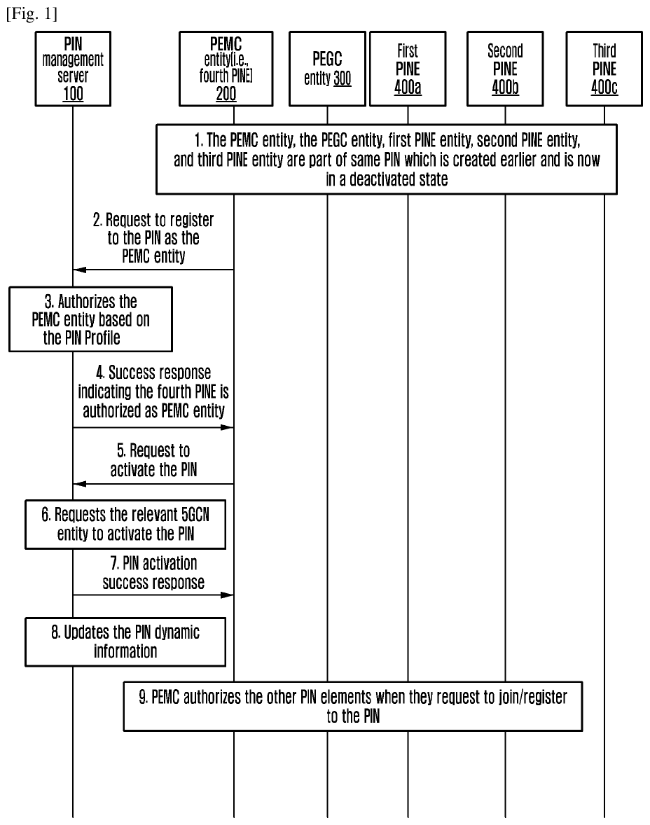

Referring now to the drawings, and more particularly to FIGS. 1 through 14, where similar reference characters denote corresponding features consistently throughout the figures, there are shown at least one embodiment.

The following abbreviations and terms have been referred in the patent disclosure:
a) 3GPP: 3^{rd} Generation Participation Project,
b) 5GC: 5G Core Network,
c) PEGC entity: PIN Element with Gateway Capability entity,
d) PEMC entity: PIN Element with Management Capability entity,
c) PIN: Personal IoT Network,
f) PIN-E: PIN Element,
g) UE: User Equipment,
h) PIN (Personal IoT Network): The Personal IoT Networks provide local connectivity between UEs and/or non-3GPP devices. The PIN includes PIN Elements (PINE) that communicate using PIN direct connection or direct network connection and is managed locally (using a PIN Element with Management Capability) (i.e., PEMC entity).
i) PINE (PIN Element): PIN Elements are UEs and/or non-3GPP devices which form part of the PIN.
j) PEMC (PIN Element with Management Capability): PIN Element which have the capability to provide means for an authorised administrator to configure and manage a PIN. The PEMC entity is a UE having the management capability.
k) PEGC (PIN Element with Gateway Capability): The PIN Elements with Gateway Capability provide means to PIN elements to register and access 5G network services. It can also help in communication between 2 PIN elements that are not within the range to use direct communication.
l) PIN Management server: A network entity which can reside in a data network or within the 3GPP core network and it provides means for creation/activation/deactivation/deletion of PIN and the authorization related aspects. It also maintains the static and dynamic information of PIN and its PIN elements. The PIN MS interfaces/communicates with other relevant 3GPP core network entities for managing the PIN.
m) PIN-ID: Unique identifier associated with a PIN.

FIG. 1 illustrates a sequence diagram of a process of PIN activation. Consider that a PEMC entity (200) (i.e., fourth PINE), a PEGC entity (300), a first PINE (400a), a second PINE (400b), and a third PINE (400c) are part of the same PIN and the PIN being activated has already been created earlier. The fourth PINE entity is capable of acting as the PEMC entity (200).
Step 1: PEMC entity (200) (i.e., fourth PINE), the PEGC entity (300), the first PINE (400a), the second PINE (400b), the third PINE (400c) are part of the same PIN which is created earlier and is now in a deactivated state.
2. Step 2: The fourth PINE entity requests the PIN MS (100) to register itself as the PEMC entity (200). The request contains the PIN ID, and PIN Element ID/PINAPP ID of the fourth PINE entity.
Step 3: The PIN MS (100) authenticates and authorizes the register request from the fourth PINE entity.
Step 4: If the fourth PINE entity is authorized to act as the PEMC entity (200), the PIN MS (100) sends the success response otherwise sends the failure and do not continue with the rest of the steps (i.e., step S-Step 9).
5. Step 5: The PEMC entity (200) (i.e., fourth PINE) requests the PIN MS (100) to activate the PIN and the request contains the PIN ID, the PIN Element ID/PINAPP ID of the fourth PINE entity, duration of the PIN to be in the active state etc.
6. Step 6: The PIN management server (100) accepts the request and requests the relevant a 5GC entity to activate the PIN as specified in the PIN ID.
Step 7: The PIN Management server (100), on getting the success response from the 5GC entity, indicates the fourth PINE entity that the PIN has been activated.
8. Step 8: The PIN management server (100) updates the dynamic PIN information with the details such as PIN state, the PIN validity duration, PIN Element ID/PINAPP ID which is authorized as PEMC entity (200) etc.
Step 9: The PEMC entity (200) (i.e., fourth PINE) also maintains the dynamic information related to the PIN and then on manages the PIN by authorizing the PIN elements which are requesting to join the PIN.

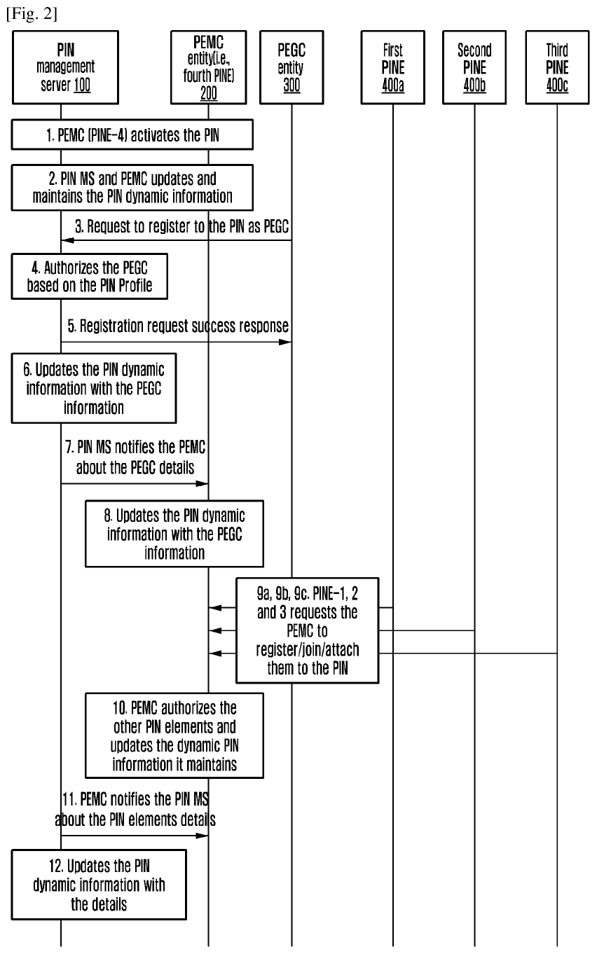

FIG. 2 illustrates a sequence diagram of a process for updating the PIN dynamic information. Consider that the PEMC entity (200) (i.e., fourth PINE), the PEGC entity (300), the first PINE (400a), the second PINE (400b), the third PINE (400c) are part of the same PIN and the PIN being activated has already been created earlier. The fourth PINE entity is authorized to act as the PEMC entity (200). The first PINE (400a), the second PINE (400b) and the third PINE (400c) know the reachability information of the PEMC entity (200).
1. Step 1: The PEMC entity (200) (i.e., fourth PINE) requests to activate the PIN and the PIN MS (100) activates it.
2. Step 2: The PEMC entity (200) (i.e., fourth PINE entity) and the PIN MS (100) updates the dynamic information of the PIN that the PIN is in the active state, PEMC entity details etc.
Step 3: The fifth PINE entity requests the PIN MS (100) to join/attach/register to the PIN as the PEGC entity (300). The request contains the PIN ID, the PIN element/PIN APP ID of the fifth PINE entity and may contain the duration it wants to act as the PEGC entity (300) etc.
4. Step 4: The PIN MS (100) authenticates and authorizes the register request from the fifth PINE entity based on the PIN profile and it maintains.
5. Step 5: The PIN MS (100) sends the success response to the fifth PINE entity confirming its role as the PEGC entity (300).
6. Step 6: The PIN MS (100) updates the dynamic information with the details of PEGC entity (300) (i.e., fifth PINE).
Step 7: The PIN MS (100) notifies the PEMC entity (200) that the fifth PINE entity is authorized to act as the PEGC entity (300) and the relevant details like PINAPP/PIN Element ID, reachability information, duration of its role as PEGC entity (300) etc.
8. Step 8: The PEMC entity (200) (i.e., fourth PINE entity) updates the dynamic information of the PIN with the details as received in the step 7.
9. Steps 9a, 9b, 9c: The first PINE (400a), the second PINE (400b) and the third PINE (400c) request the PEMC entity (200) to register to the PIN.
10. Step 10: The PEMC entity (200) (i.e., fourth PINE entity) authorizes the requests from the PIN elements based on the PIN profiles and the PIN element profiles it maintains, and responds success, if they are authorized to join the PIN. The response contains the details of the PIN such as PIN validity, the PEGC entity reachability information, the PIN elements acting as relay and their reachability information. The PEMC entity (200) (i.e., fourth PINE entity) also updates the dynamic information of the PIN with the details of PIN elements being authorized and their reachability information etc.
11. Step 11: The PEMC entity (200) (i.e., fourth PINE entity) notifies the PIN management server (100) about the details of the PIN elements being registered.
12. Step 12: The PIN management server (100) updates the dynamic PIN information with the details received in Step 11.

The PEMC entity (200) notifies the PIN MS (100) whenever the PIN element joins or leaves the PIN or when their capability changes etc.

Below are list of scenarios but not limited to when the PIN dynamic information is to be updated:
a. When the PIN is activated by the PIN management server (100), based on the request from the PEMC entity (200) or from the authorized user or the PIN management server (100), itself activating the PIN based on the time period etc., the PIN MS (100) updates the PIN dynamic information.
b. When the PEMC entity (200)/PEGC PIN elements, the PIN MS (100) updates the PIN dynamic information.
c. When the PIN elements requests to join the PIN and successfully joined the PIN, the PEMC entity (200) updates and notifies the PIN MS (100) for it to update.
d. When any of the PIN elements leaves the PIN, the PEMC entity (200) updates and notifies the PIN MS (100) for it to update
e. When any of the PIN element is detected to be unavailable or not reachable
f. When the role of PEMC entity (200)/PEGC PIN elements changes, the PIN MS (100) updates the PIN dynamic information and notifies the PINE which is taking the role of the PEMC entity (200).
g. When any guest PIN element joins the PIN, the PEMC entity (200) updates the dynamic PIN information. The PEMC entity (200) maintains and also notifies the PIN Management server (100) to updates the PIN dynamic information it is managing.
h. When the capabilities or service offered by the PIN or PIN elements changes, on receiving the capability change indication from the PIN elements, the PEMC entity (200) updates its PIN dynamic information and notifies the PIN MS (100) for updating.
i. When the PIN is deactivated.

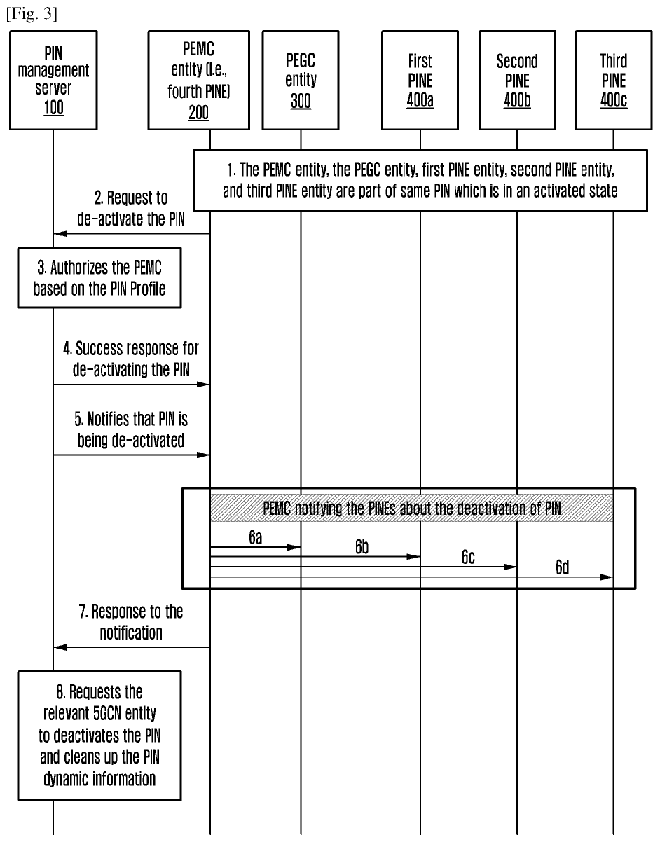

FIG. 3 illustrates a sequence diagram of a process of deactivating the PIN by the PEMC entity (200). Consider that the fourth PINE entity is authorized to act as PEMC entity (200) and the PEMC entity (200) (i.e., fourth PINE entity) decides to de-activate the PIN.
1. Step 1: The fourth PINE entity, the PEGC entity (300), the first PINE (400a), the second PINE (400b), and the third PINE (400c) are part of same PIN which is in the active state.
2. Step 2: The PEMC entity (200) (i.e., fourth PINE entity) decides to de-activate the PIN and sends the request to deactivate the PIN to the PIN MS (100). Decision reason by the PEMC entity (200) to deactivate the PIN may be PIN validity duration is expiring or all the PIN elements have left the PIN or for any other reasons which could be implementation specific. The request carries the PIN identifier of the PIN to be deactivated, the PIN Element identifier of the PEMC entity (200) and the reason for deactivating the PIN.
3. Step 3: The PIN MS (100) determines whether the PEMC entity (200) (i.e., fourth PINE entity) is authorized to de-activate the PIN by determining the PIN profile.
4. Step 4: The PIN MS (100) sends the success response to the PEMC entity (200) for the request to deactivate the PIN.
5. Step 5: The PIN MS (100) notifies the PEMC entity (200) that the PIN is being deactivated.
6. Step 6: The PEMC entity (200), on receiving the PIN deactivation notification from the PIN MS (100), notifies all the PIN elements which are currently attached/joined/registered to the PIN that PIN is being deactivated.
7. Step 7: The PEMC entity (200) (i.e., fourth PINE entity) sends the response to the deactivation notification from PIN MS (100).
8. Step 8: The PIN MS (100) requests the relevant 5GCN entity to deactivate the PIN.

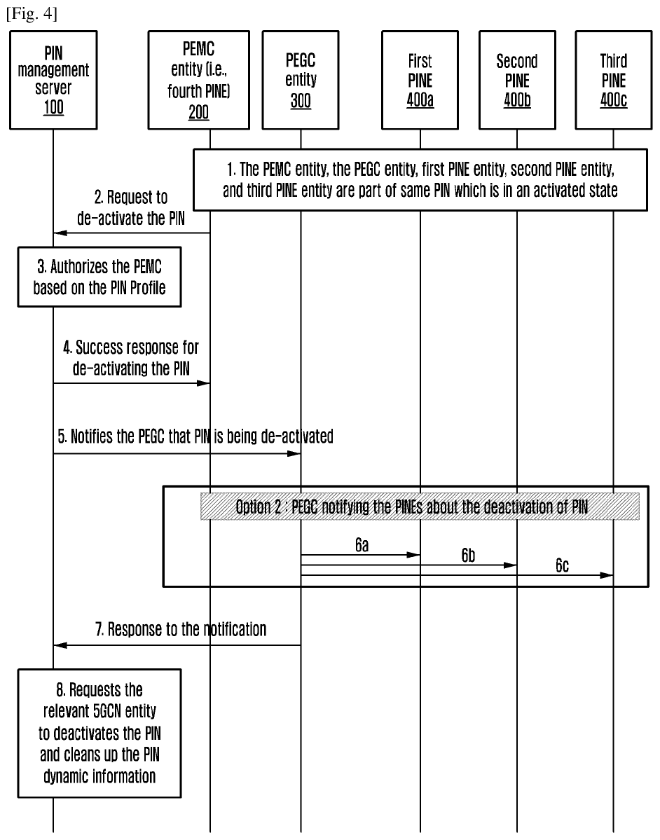

FIG. 4 illustrates a sequence diagram of a process of deactivating the PIN by the PEMC entity (200). Consider that the fourth PINE entity is authorized to act as the PEMC entity (200) and the PEMC entity (200) (i.e., fourth PINE entity) decides to deactivate the PIN.
1. Step 1: The fourth PINE entity, the PEGC entity (300), the first PINE (400a), the second PINE (400b), and the third PINE (400c) are part of the same PIN which is in the active state.
2. Step 2: The PEMC entity (200) (i.e., fourth PINE entity) decides to de-activate the PIN and sends the request to deactivate the PIN to the PIN MS (100). The reason by the PEMC entity (200) to deactivate the PIN may be PIN validity duration is expiring or all the PIN elements have left the PIN or for any other reasons which could be implementation specific. The request carries the PIN identifier of the PIN to be deactivated, the PIN Element identifier of the PEMC entity (200) and the reason for deactivating the PIN.
3. Step 3: The PIN MS (100) determines whether the PEMC entity (200) (i.e., fourth PINE entity) is authorized to de-activate the PIN by determining the PIN profile.
4. Step 4: The PIN MS (100) sends the success response to the PEMC entity (200) for the request to deactivate the PIN.
5. Step 5: The PIN MS (100) notifies the PEGC entity (300) that the PIN is being deactivated.
6. Step 6: The PEGC entity (300), on receiving the PIN deactivation notification from the PIN MS (100), notifies all the PIN elements which are currently attached/joined/registered to the PIN that PIN is being deactivated.
7. Step 7: The PEGC entity (300) sends the response to the deactivation notification from the PIN MS (100).
8. Step 8: The PIN MS (100) request the relevant 5GCN entity to deactivate the PIN. (The step S can occur at any time after step S):

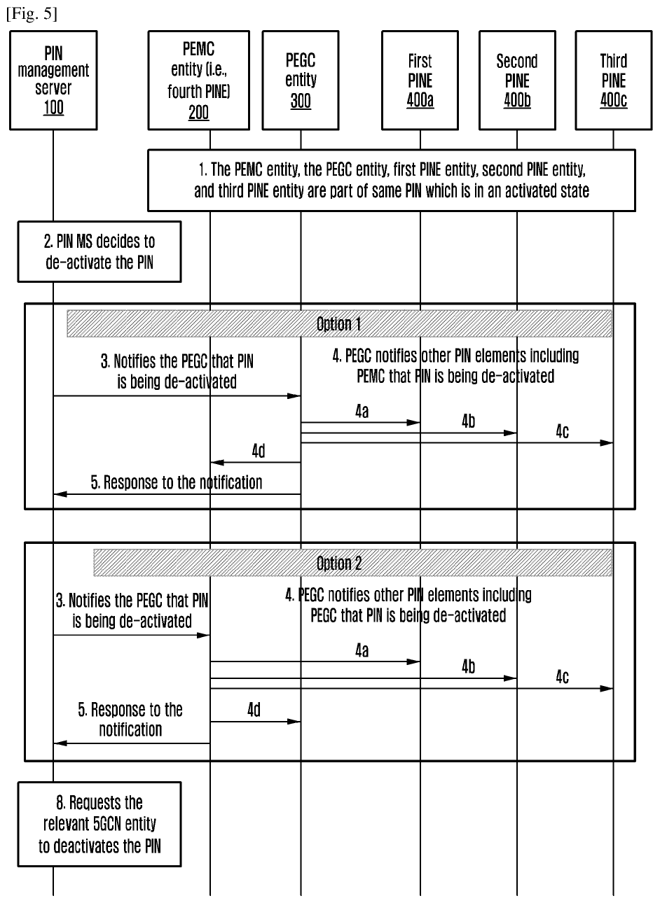

FIG. 5 illustrates a sequence diagram of a process of deactivating the PIN by the PIN MS (100). In an embodiment, the below operations used for deactivating the PIN by the PIN MS (100).
1. Step 1: the fourth PINE entity, PEGC entity (300), first PINE (400a), the second PINE (400b), and the third PINE (400c) are part of the same PIN which is in active state.
2. Step 2: The PIN MS (100) decides to de-activate the PIN. The reason by PIN MS (100) to deactivate the PIN could be PIN validity duration is expiring or all the PIN elements have left the PIN or for any other reasons which could be implementation specific.
3. Step 3: The PIN MS (100) notifies the PEGC entity (300) that the PIN is being deactivated. The notification request contains the identifier of the PEGC entity (300), identifier of the PIN being deactivate and may be the reason for deactivation.
4. Step 4: The PEGC entity (300), on receiving the PIN deactivation notification from the PIN MS (100), notifies all the PIN elements which are currently attached/joined/registered to the PIN that PIN is being deactivated.
5. Step 5: The PEGC entity (300) sends the response to the deactivation notification from the PIN MS (100).
6. Step 6: The PIN MS (100) requests the relevant 5GCN entity to deactivate the PIN.

In another embodiment, the below operations used for deactivating the PIN by the PIN MS (100).
1. Step 1: the fourth PINE entity, the PEGC entity (300), the first PINE (400a), the second PINE (400b), and the third PINE (400c) are part of same PIN which is in active state.
2. Step 2: The PIN MS (100) decides to de-activate the PIN. The reason by the PIN MS (100) to deactivate the PIN could be PIN validity duration is expiring or all the PIN elements have left the PIN or for any other reasons which could be implementation specific.
3. Step 3: The PIN MS (100) notifies the PEMC entity (200) that the PIN is being deactivated. The notification request contains the identifier of the PEMC entity (200), identifier of the PIN being deactivated and may be the reason for deactivation.
4. Step 4: The PEMC entity (200), on receiving the PIN deactivation notification from the PIN MS (100), notifies all the PIN elements which are currently attached/joined/registered to the PIN that PIN is being deactivated.
5. Step 5: The PEMC entity (200) sends the response to the deactivation notification from the PIN MS (100).
6. Step 6: The PIN MS (100) requests the relevant 5GCN entity to deactivate the PIN.

In an embodiment herein, once the PIN MS (100) decides to deactivate the PIN it can individually notify all the PIN elements in the PIN that the PIN is being deactivated and the notify request contains the PIN identifier of the PIN being deactivated, PIN element Id to which the notification is targeted.

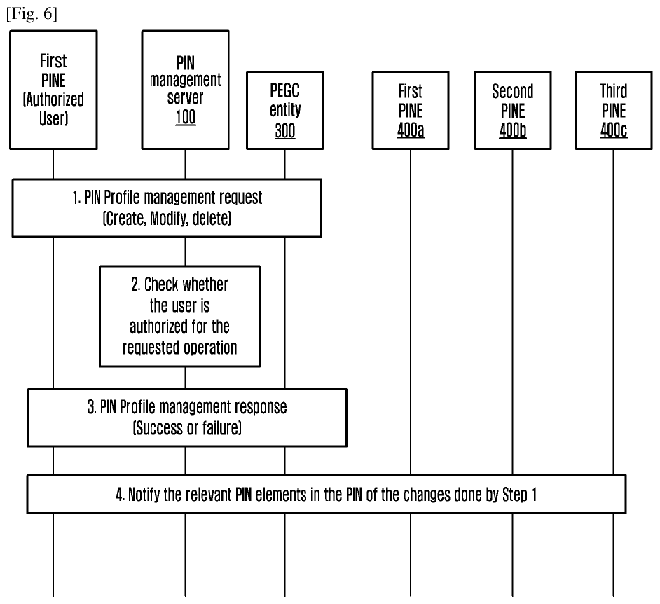

FIG. 6 illustrates a sequence diagram of a process of performing PIN profile management by an authorized user. Consider that the fourth PINE entity, the PEGC entity (300), the first PINE (400a), the second PINE (400b), and the third PINE (400c) are part of the same PIN which is in an active state.
1. Step 1: An authorized user from PINE-A sends the PIN profile management request to the PIN MS (100). The PIN profile management request can be any of the below:
   a. Request to create a PIN element profile,
   b. Request to create a PIN profile,
   c. Request to modify the PIN profile,
   d. Request to modify the PIN element profile,
   c. Request to delete the PIN element profile, and
   f. Request to delete the PIN profile.
2. Step 2: The PIN MS (100) determines whether the user is authorized to perform the requested operation. The authorization is based on the local configuration present at the PIN MS.
3. Step 3: The PIN MS (100) sends the response to the authorized user as ‘success’ after completing the requested operation or ‘failure’ with the failure reason. The failure reason is because of the user not being authorized or the requested operation is not completed.
4. Step 4: The PIN MS (100) notifies the relevant PIN elements about the changes made because of step 1, if it needs to be notified. If the request is to delete the PIN profile and if the corresponding PIN is active and using that profile, the PIN MS (100) requests the 3GPP CN to deactivate and delete the PIN. If the request is to delete the PIN element profile and the corresponding PIN element is in activated/registered state, it is removed from the PIN. If the request is to modify the PIN element profile, a corresponding PIN element is notified about the change.

The PINE-A, which the authorized user is using to update the PIN profiles, can be residing inside the PIN or outside of the PIN.

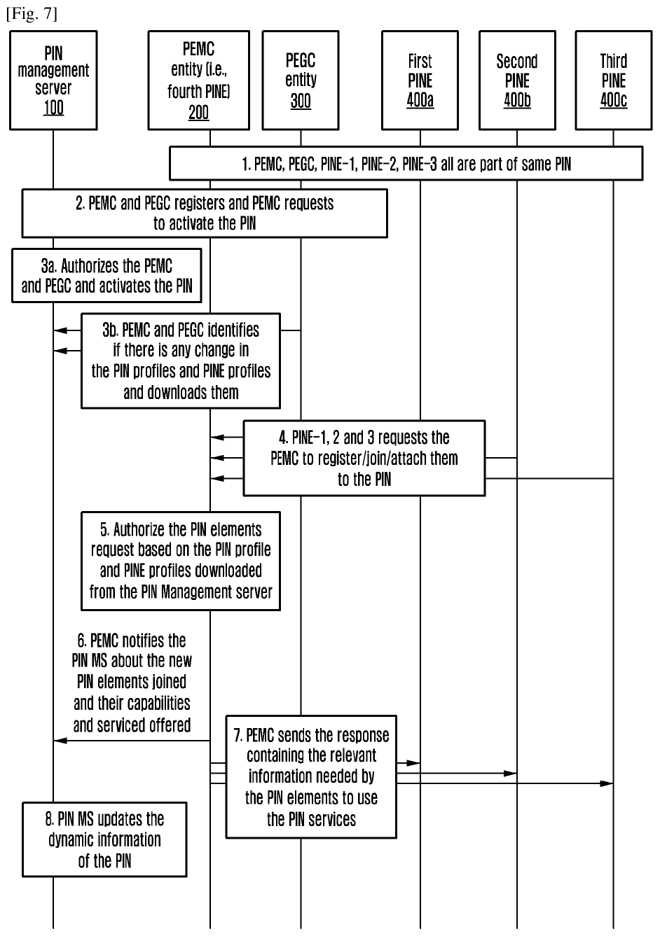

FIG. 7 illustrates a sequence diagram of a process for PIN management. Consider that the PIN being activated has already been created earlier and the PIN elements 1,2 and 3 have already been discovered the PIN Element is authorized to act as PEMC entity (200)
1. Step 1: PEMC entity (200), the PEGC entity (300), first PINE (400a), the second PINE (400b), and the third PINE (400c) all are part of the same PIN.
2. Step 2: The PEMC entity (200) and the PEGC entity (300) registers with the PIN Management server (100) and requests to activate the PIN,
3. Step 3: The PIN Management server (100) accepts the request and authorizes the PEMC entity (200) and the PEGC entity (300) based on the information available in the PIN profile and activates the PIN.
4. Step 4: The PEMC entity (200) and the PEGC entity (300) identifies if there is any change in the PIN profile and PIN elements profile compared to what is locally available and downloads the changes profiles, if any.
5. Step 5: The PIN Elements (i.e., first PINE-third PINE) request the PEMC entity (200) to join the PIN including but not limited to the below information:
a. PIN Element identifier,
b. Time duration to be associated with PIN,
c. Capabilities and services offered by the PIN Element,
d. Version of the PIN element profile and PIN profile currently available at the PIN element,
e. Whether it wants to act as relay, and
f. Reachability information (The reachability information is the IP address or any other information which can be used to reach the PIN element).
6. Step 6: The PEMC entity (200) determines whether the PIN elements (i.e., first PINE-third PINE) are allowed to join the PIN based on the PIN element profiles and authorizes them accordingly.
7. Step 7: The PEMC entity (200) sends the confirmation to the PIN elements (i.e., first PINE-third PINE) and also the current version of PIN Profile and PIN element profile if latest is not available with the PIN elements and also the PEGC reachability information. Alternatively, the PEMC entity (200) may send the current version of these profiles and if there is a mismatch the PIN elements can download the latest from the PIN Management server (100) via the PEGC entity (300).
8. Step 8: The PEMC entity (200) notifies the PIN Management server (100) regarding the PIN elements that are authorized to join and their capabilities and reachability information.
9. Step 9: The PIN Management server (100) updates the dynamic PIN information and maintains with the dynamic PIN information.

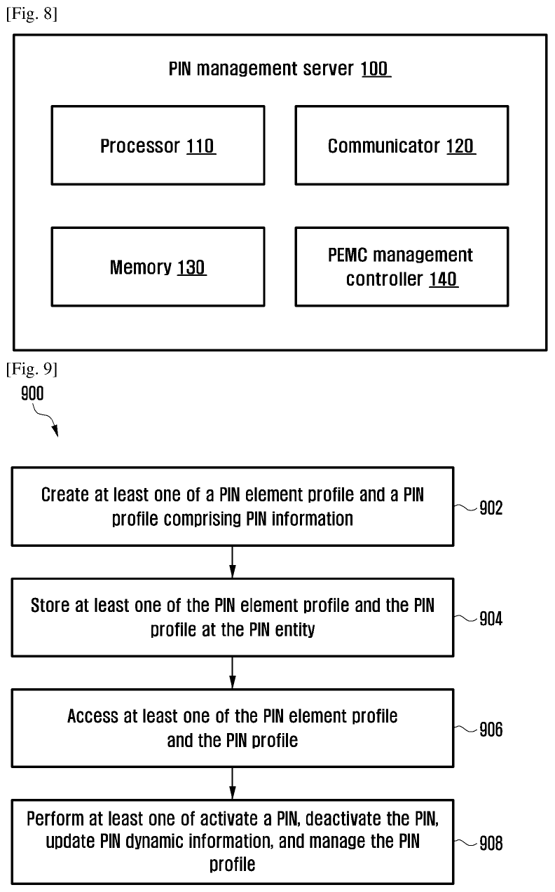

FIG. 8 illustrates various hardware components of the PIN management server (100), according to the embodiments as disclosed herein. In general, in order to manage the PIN, information related to the PIN, information of each PIN elements, context or dynamic information of the PIN needs to be maintained by the PIN Management server (100), and the PIN element acting as the PEMC entity (200) and PEGC entity (300).

The PIN profile includes of storage and access of PIN information including the below but not limited to:
a. PIN Identifier and PIN name;
b. maximum number of PIN elements that can be configured within the PIN;
c. List of PIN elements configured and their life time to be associated with the PIN;
d. Services Offered by the PIN;
e. List of PIN elements that can act as PEGC entity (300) and may also contain their validity duration. Validity duration specifies how long the PINE can act as PEGC entity (300) and also the time period;
f. List of PIN elements that can act as PEMC entity (200) and may also contain their validity duration. Validity duration specifies how long the PINE can act as PEMC entity (200) and also the time period;
g. List of PIN elements that can act as Relay;
h. Life Span of the PIN/Time period of the PIN when it can be active;
i. Whether the PIN is allowed to let guest PIN elements join; and
j. Geographical area(s) where the PIN can be active.

The PIN element profile includes storage and access of PIN element information including the below but not limited to:
a. PIN Element Identifier/PINAPP ID;
b. List of PINs it is authorized to join;
c. Services Offered by the PIN element;
d. Whether it is authorized to act as PEGC entity (300)/PEMC entity (200)/Relay;
c. List of services it can access in a PIN;
f. List of PIN elements it can communicate with;
g. List of PIN elements it can use as Relay;
h. Whether it can use PEGC entity (300) to communicate with 5GC;
i. Connection type allowed-Direct or indirect;
j. Discoverable by other PIN elements or not and list of PIN elements the PINE can be discoverable; and
k. Duration of the PIN element when it can be active or associated with the PIN (for each PIN).

The PIN element profile can be shared by each PIN elements when they register with PIN or they can be pre-provisioned by the authorized user and the PIN element can choose the profile during registration by passing the appropriate identifier which uniquely identifies the profile to be used.

There could be multiple profiles, which exist for PIN and the PEMC entity (200) can choose which profile to be used while creation or activation of PIN. Similarly, there could be multiple profiles exists for each PIN element and PIN element can choose which profile to be applied/used while they register to the PIN based on the role or capability they offer.

Whenever the PIN is activated, the PIN Management server (100) maintains the dynamic information related to the PIN. The same information is available at the PEMC entity (200) and also at the PEGC entity (300). Below is the dynamic information related to the PIN.
a. PIN Identifier;
b. List of PIN elements currently active, their PIN IDs, services offered by them, whether they have the capability to act as PEMC entity (200), PEGC entity (300) or Relay inside the PIN and their reachability information. The reachability information could be the IP address or any other information that can be used to reach a particular PIN element;
c. PIN element ID and the reachability information of the PINE acting as the PEMC entity (200);
d. PIN element ID and the reachability information of the PINE acting as PEGC entity (300);
e. List of PIN element ID and the reachability information of the PINEs acting as Relay;
f. List of Services currently offered by the PIN; and
g. List of Guest PIN elements present in the PIN and their reachability information.

The information could be used whenever there is a request from a PIN element or a guest PIN element requesting to join the PIN if a particular service is offered by the PIN.

In an embodiment, the PIN management server (100) includes a processor (110), a communicator (120), a memory (130) and a PIN management controller (140). The processor (110) is coupled with the communicator (120), the memory (130) and the PIN management controller (140).

The PIN management controller (140) creates the PINE profile and the PIN profile comprising the PIN information. Further, the PIN management controller (140) stores the PIN element profile and the PIN profile at the PIN entity. The PIN management controller (140) accesses the PIN element profile and the PIN profile.

In an embodiment, the PIN management controller (140) receives the request message from the first PINE (400a) from the plurality of PINEs (400a-400c) for registering to the PIN as the PEMC entity (200). Further, the PIN management controller (140) authenticates and authorizes the first PINE (400a) as the PEMC entity (200) based on the PIN profile. Further, the PIN management controller (140) sends the response message to the first PINE (400a), where the response message indicates that the first PINE (400a) is authorized as the PEMC entity (200). Further, the PIN management controller (140) receives the activation request message from the first PINE (400a) for activating the PIN based on the response message. Further, the PIN management controller (140) requests the 5GC entity to activate the PIN based on the activation request message. Further, the PIN management controller (140) sends the PIN activation success response to the first PINE (400a). Further, the PIN management controller (140) updates the PIN dynamic information.

In an embodiment, the PIN management controller (140) updates and maintains the PIN dynamic information. Further, the PIN management controller (140) receives a request message from the second PINE (400b) from the plurality of PINEs for registering to the PIN as the PEGC entity (300). Further, the PIN management controller (140) authenticates and authorizes the second PINE (400b) as the PEMC entity (200) based on the PIN profile. Further, the PIN management controller (140) sends the response message to the second PINE (400b), where the response message indicates that the second PINE (400b) is authorized as the PEGC entity (300). Further, the PIN management controller (140) updates the PIN dynamic information associated with information associated with the PEGC entity (300), where the information comprises at least one of the PINAPP ID, a PIN element ID, a reachability information, and a validity duration associated with the PEGC entity (300). Further, the PIN management controller (140) notifies the information associated with the PEGC entity (300) to the PEMC entity (200).

In an embodiment, the PIN management controller (140) receives the request message from the first PINE (400a) from the plurality of PINEs for deactivating the PIN. Further, the PIN management controller (140) authorizes the first PINE (400a) as the PEMC entity (200) based on the PIN profile. Further, the PIN management controller (140) sends a response message to the first PINE (400a), where the response message indicates the de-activating the PIN. Further, the PIN management controller (140) notifies that the PIN is being de-activated, where the PEMC entity (200) notifies the plurality of PINEs about the deactivation of the PIN. Further, the PIN management controller (140) receives a response to the deactivation notification message from the PEMC entity (200). Further, the PIN management controller (140) sends a request message to the 5GC entity to deactivate the PIN and cleans the PIN dynamic information.

In an embodiment, the PIN management controller (140) receives the request message from the first PINE (400a) from the plurality of PINEs for deactivating the PIN. Further, the PIN management controller (140) authorizes the first PINE (400a) as the PEMC entity (200) based on the PIN profile. Further, the PIN management controller (140) sends the response message to the first PINE (400a), where the response message indicates the de-activating the PIN. Further, the PIN management controller (140) notifies that the PIN is being de-activated to the PEGC entity (300), where the PEGC entity (300) notifies the plurality of PINEs about the deactivation of the PIN. Further, the PIN management controller (140) receives the response to the deactivation notification message from the PEGC entity (300). Further, the PIN management controller (140) sends the request message to the 5GC entity to deactivate the PIN and clean the PIN dynamic information.

In an embodiment, the PIN management controller (140) receives the PIN profile management request from an user associated with the first PINE (400a). Further, the PIN management controller (140) determines whether the user is authorized to perform the requested operation, where the determination is based on a local configuration present at the PIN management server (100). Further, the PIN management controller (140) sends the response to the authorized user as success after completing a requested operation or failure with a failure reason. Further, the PIN management controller (140) notifies the PINE from the plurality of PINEs about the changes corresponding to create the PIN element profile, create the PIN profile, modify the PIN profile, modify the PIN element profile, delete the PIN element profile, and delete the PIN profile.

The PIN management controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 8 illustrates various hardware components of the PIN management server (100) but it is to be understood that other embodiments are not limited thereon. In other embodiments, the PIN management server (100) may include less or more number of components. Further, the labels or names of the components are used only for illustrative purpose and does not limit the scope of the disclosure. One or more components can be combined together to perform same or substantially similar function in the PIN management server (100).

FIG. 9 is a flow chart (900) illustrating a PIN management method, according to the embodiments as disclosed herein. The operations (902-908) are handled by the PIN management controller (140).

At 902, the method includes creating at least one of the PIN element profile and the PIN profile comprising the PIN information. At 904, the method includes storing at least one of the PIN element profile and the PIN profile at the PIN entity. At 906, the method includes accessing at least one of the PIN element profile and the PIN profile. At 908, the method includes performing at least one of activating a PIN, deactivating the PIN, updating PIN dynamic information, and managing the PIN profile.

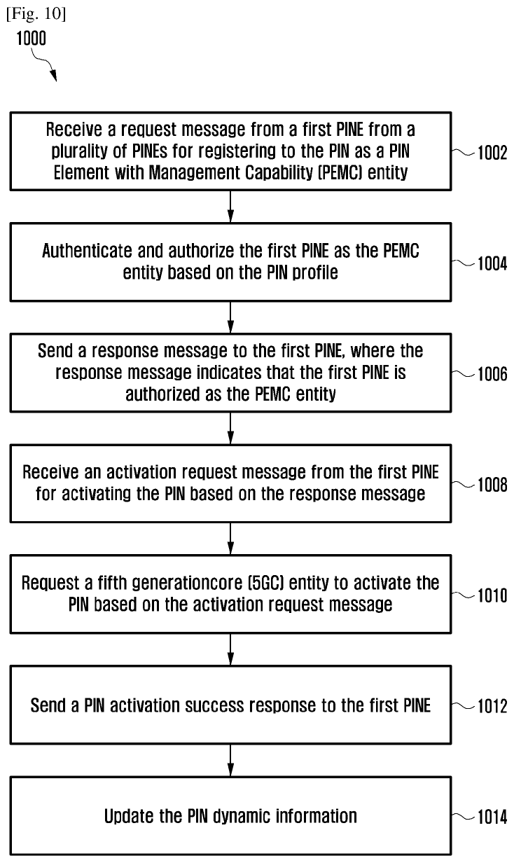

FIG. 10 is a flow chart (1000) illustrating a method for activating the PIN in accordance with the FIG. 9, according to the embodiments as disclosed herein. The operations (1002-1014) are handled by the PIN management controller (140).

At 1002, the method includes receiving the request message from the first PINE (400a) from the plurality of PINEs for registering to the PIN as the PEMC entity (200). At 1004, the method includes authenticating and authorizing the first PINE (400a) as the PEMC entity (200) based on the PIN profile. At 1006, the method includes sending a response message to the first PINE (400a), where the response message indicates that the first PINE (400a) is authorized as the PEMC entity (200). At 1008, the method includes receiving an activation request message from the first PINE (400a) for activating the PIN based on the response message. At 1010, the method includes requesting a 5GC entity to activate the PIN based on the activation request message. At 1012, the method includes sending the PIN activation success response to the first PINE (400a). At 1014, the method includes updating the PIN dynamic information.

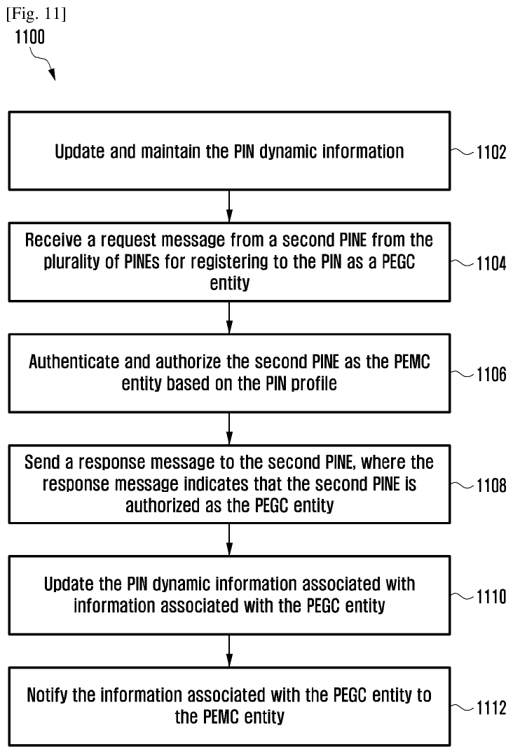

FIG. 11 is a flow chart (1100) illustrating a method for updating the PIN dynamic information in accordance with the FIG. 9, according to the embodiments as disclosed herein. The operations (1102-1112) are handled by the PIN management controller (140).

At 1102, the method includes updating and maintaining the PIN dynamic information. At 1104, the method includes receiving the request message from the second PINE (400b) from the plurality of PINEs for registering to the PIN as the PEGC entity (300). The request message includes the PIN ID, the PIN element, the PIN APP ID associated with the second PINE (400b) and the validity duration associated with the second PINE (400b). At 1106, the method includes authenticating and authorizing the second PINE (400b) as the PEMC entity (200) based on the PIN profile. At 1108, the method includes sending the response message to the second PINE (400b), where the response message indicates that the second PINE (400b) is authorized as the PEGC entity (300).

At 1110, the method includes updating the PIN dynamic information associated with information associated with the PEGC entity (300), where the information comprises the PINAPP ID, the PIN element ID, the reachability information, and the validity duration associated with the PEGC entity (300). At 1112, the method includes notifying the information associated with the PEGC entity (300) to the PEMC entity (200).

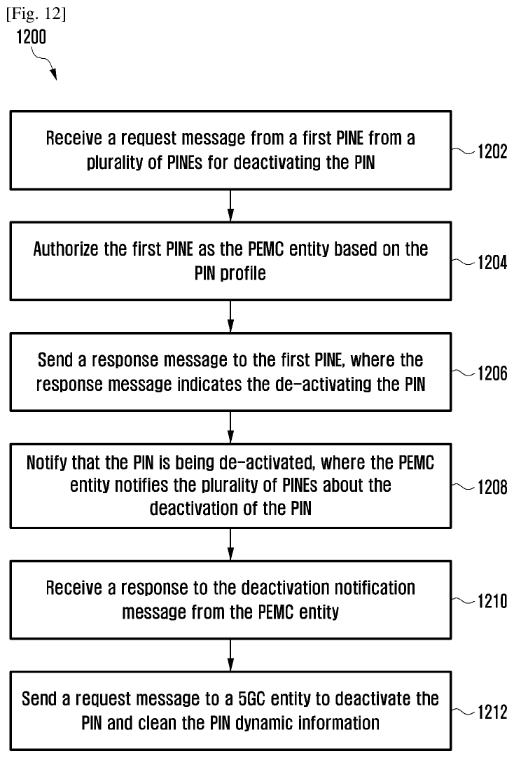

FIG. 12 is a flow chart (1200) illustrating a method for deactivating the PIN in accordance with the FIG. 9, according to the embodiments as disclosed herein. The operations (1202-1212) are handled by the PIN management controller (140).

At 1202, the method includes receiving the request message from the first PINE (400a) from the plurality of PINEs for deactivating the PIN. At 1204, the method includes authorizing the first PINE (400a) as the PEMC entity (200) based on the PIN profile. At 1206, the method includes sending the response message to the first PINE (400a), where the response message indicates the de-activating the PIN. At 1208, the method includes notifying that the PIN is being de-activated, where the PEMC entity (200) notifies the plurality of PINEs about the deactivation of the PIN. At 1210, the method includes receiving the response to the deactivation notification message from the PEMC entity (200). At 1212, the method includes sending the request message to the 5GC entity to deactivate the PIN and clean the PIN dynamic information.

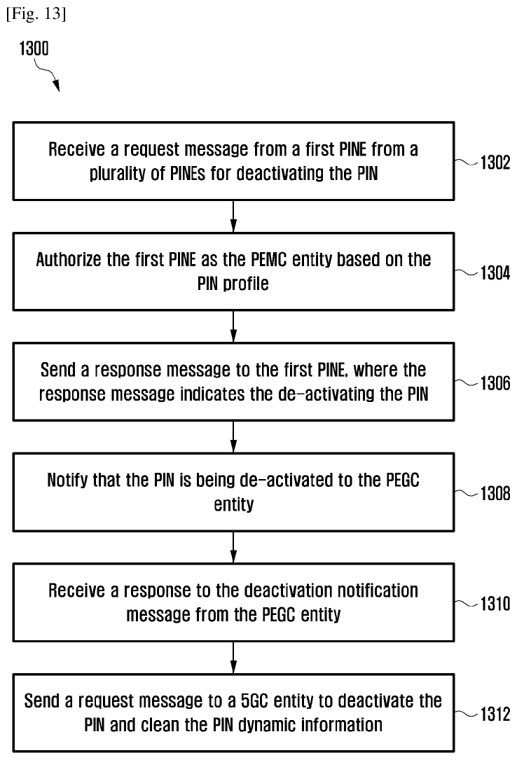

FIG. 13 is a flow chart (1300) illustrating a method for deactivating the PIN in accordance with the FIG. 9, according to the embodiments as disclosed herein. The operations (1302-1312) are handled by the PIN management controller (140).

At 1302, the method includes receiving the request message from the first PINE (400a) from the plurality of PINEs for deactivating the PIN (500). At 1304, the method includes authorizing the first PINE (400a) as the PEMC entity (200) based on the PIN profile. At 1306, the method includes sending the response message to the first PINE (400a), where the response message indicates the de-activating the PIN.

At 1308, the method includes notifying the that the PIN is being de-activated to the PEGC entity (300), where the PEGC entity (300) notifies the plurality of PINEs about the deactivation of the PIN. At 1310, the method includes receiving the response to the deactivation notification message from the PEGC entity (300). At 1312, the method includes sending the request message to the 5GC entity to deactivate the PIN and clean the PIN dynamic information.

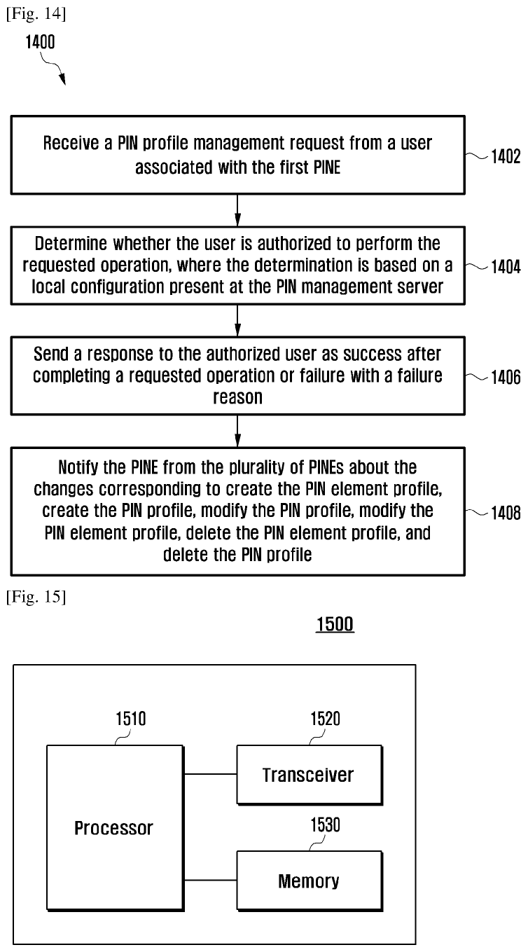

FIG. 14 is a flow chart (1400) illustrating a method for managing the PIN profile in accordance with the FIG. 9, according to the embodiments as disclosed herein. The operations (S1402-S1408) are handled by the PIN management controller (140).

At 1402, the method includes receiving the PIN profile management request from the user associated with the first PINE (400a). At 1404, the method includes determining whether the user is authorized to perform the requested operation, where the determination is based on the local configuration present at the PIN management server (100). At 1406, the method includes sending the response to the authorized user as success after completing a requested operation or failure with the failure reason. At 1408, the method includes notifying the PINE from the plurality of PINEs about the changes corresponding to create the PIN element profile, create the PIN profile, modify the PIN profile, modify the PIN element profile, delete the PIN element profile, and delete the PIN profile.

The PIN management server (100) activates the PIN and notifies the corresponding PIN entities which are explained in FIG. 8 to FIG. 14. But, the same operation applicable to other entities as well (e.g., PEGC entity (300) and the PEMC entity (200)). The PEGC entity (300) or the PEMC entity (200) can also activate the PIN by sending the PIN activate request to the PIN management server (100). In another embodiment, the authorized user can request to activate the PIN from outside the PIN by sending the PIN activate request to the management server (100).

According to an embodiment a Personal Internet of Things (IoT) Network (PIN) management method may be provided.

According to an embodiment, the method may include creat, by a PIN entity, at least one of a PIN Element (PINE) profile and a PIN profile comprising PIN information.

According to an embodiment, the method may include storing, by the PIN entity, at least one of the PIN element profile and the PIN profile at the PIN entity.

According to an embodiment, the method may include accessing, by the PIN entity, at least one of the PIN element profile and the PIN profile.

According to an embodiment, the method may include performing, by the PIN entity, at least one of: activating a PIN, deactivating the PIN, updating PIN dynamic information, and managing the PIN profile.

According to an embodiment, where activating the PIN may include: receiving, by a PIN management server (100), a request message from a first PINE (400a) from a plurality of PINEs for registering to the PIN as a PIN Element with Management Capability (PEMC) entity (200); authenticating and authorizing, by the PIN management server (100), the first PINE (400a) as the PEMC entity (200) based on the PIN profile; sending, by the PIN management server (100), a response message to the first PINE (400a), wherein the response message indicates that the first PINE (400a) is authorized as the PEMC entity (200); receiving, by the PIN management server (100), an activation request message from the first PINE (400a) for activating the PIN based on the response message; requesting, by the PIN management server (100), a fifth generation core (5GC) entity to activate the PIN based on the activation request message; sending, by the PIN management server (100), a PIN activation success response to the first PINE (400a); and updating, by the PIN management server (100), the PIN dynamic information.

According to an embodiment, the request message may include at least one of a PIN identifier (ID), and a PIN element ID.

According to an embodiment, the activation request message may include at least one of the PIN ID, the PIN element ID, the PINAPP ID associated with the first PINE (400a), and a duration of the PIN to be in an active state.

According to an embodiment, the PIN dynamic information may include a PIN state associated with the first PINE (400a), a PIN validity duration associated with the first PINE (400a), the PIN element ID associated with the first PINE (400a) and the PINAPP ID associated with the first PINE (400a).

According to an embodiment, updating the PIN dynamic information may include: updating and maintaining, by the PIN management server (100) and the PEMC entity (200), the PIN dynamic information; receiving, by the PIN management server (100), a request message from a second PINE (400b) from the plurality of PINEs for registering to the PIN as a PIN Element with Gateway Capability (PEGC) entity (300), wherein the request message comprises a PIN ID, a PIN element, a PIN APP ID associated with the second PINE (400b) and a validity duration associated with the second PINE (400b); authenticating and authorizing, by the PIN management server (100), the second PINE (400b) as the PEMC entity (200) based on the PIN profile; sending, by the PIN management server (100), a response message to the second PINE (400b), wherein the response message indicates that the second PINE (400b) is authorized as the PEGC entity (300); updating, by the PIN management server (100), the PIN dynamic information associated with information associated with the PEGC entity (300), wherein the information comprises at least one of the PINAPP ID, a PIN element ID, a reachability information, and a validity duration associated with the PEGC entity (300); and notifying, by the PIN management server (100), the information associated with the PEGC entity (300) to the PEMC entity (200).

According to an embodiment, the method may include updating, by the PEMC entity (200), the PIN dynamic information associated with the information.

According to an embodiment, the method may include receiving, by the PEMC entity (200), at least one of a register request, a join request, an attach request from a third PINE (400c) from the plurality of PINEs to join with the PIN.

According to an embodiment, the method may include authorizing, by the PEMC entity (200), the third PINE (400c).

According to an embodiment, the method may include updating, by the PEMC entity (200), the PIN dynamic information associated with the third PINE (400c).

According to an embodiment, the method may include receiving, by the PEMC entity (200), a notification comprising PIN elements details from the PIN management server (100).

According to an embodiment, the method may include notifying, by the PEMC entity (200), an information to the PIN management server (100).

According to an embodiment, the information may include at least one of joining the PINE, leaving the PINE and capability change of the PIN entity.

According to an embodiment, the PIN dynamic information may be updated, in case that at least one of: a) the PIN is activated by the PIN management server (100) based on a request message from at least one of the PEMC entity (200) and an authorized user, b) the PIN management server (100) updates the PIN dynamic information while registering the PEMC entity (200) or the PEGC entity (300), c) the PEMC entity (200) updates the PIN dynamic information and notifies the PIN management server (100) for updating the PIN dynamic information when one of the PIN element joins the PIN or the PIN element leaves the PIN, d) the PIN element is detected to be unavailable or not reachable, e) a role of the PEMC entity (200) is changed, f) the capabilities or service offered by the PIN or PIN elements changes, g) a role of the PEGC entity (300) is changed, and h) the PIN is deactivated.

According to an embodiment, deactivating the PIN may include: receiving, by the PIN management server (100), a request message from a first PINE (400a) from a plurality of PINEs for deactivating the PIN; authorizing, by the PIN management server (100), the first PINE (400a) as the PEMC entity (200) based on the PIN profile; sending, by the PIN management server (100), a response message to the first PINE (400a), wherein the response message indicates the de-activating the PIN; notifying, by the PIN management server (100), that the PIN is being de-activated, wherein the PEMC entity (200) notifies the plurality of PINEs about the deactivation of the PIN; receiving, by the PIN management server (100), a response to the deactivation notification message from the PEMC entity (200); and sending, by the PIN management server (100), a request message to a fifth generation core (5GC) entity to deactivate the PIN and clean the PIN dynamic information.

According to an embodiment, deactivating the PIN may include: receiving, by the PIN management server (100), a request message from a first PINE (400a) from a plurality of PINEs for deactivating the PIN; authorizing, by the PIN management server (100), the first PINE (400a) as the PEMC entity (200) based on the PIN profile; sending, by the PIN management server (100), a response message to the first PINE (400a), wherein the response message indicates the de-activating the PIN; notifying, by the PIN management server (100), that the PIN is being de-activated to the PEGC entity (300), wherein the PEGC entity (300) notifies the plurality of PINEs about the deactivation of the PIN; receiving, by the PIN management server (100), a response to the deactivation notification message from the PEGC entity (300); and sending, by the PIN management server (100), a request message to a fifth generation core (5GC) entity to deactivate the PIN and clean the PIN dynamic information.

According to an embodiment, managing the PIN profile may include: receiving, by the PIN management server (100), a PIN profile management request from an user associated with the first PINE (400a); determining, by the PIN management server (100), whether the user is authorized to perform the requested operation, wherein the determination is based on a local configuration present at the PIN management server (100); sending, by the PIN management server (100), a response to the authorized user as success after completing a requested operation or failure with a failure reason; and notifying, by the PIN management server (100), a PINE from the plurality of PINEs about the changes corresponding to create the PIN element profile, create the PIN profile, modify the PIN profile, modify the PIN element profile, delete the PIN element profile, and delete the PIN profile.

According to an embodiment, PIN profile management request may include at least one of a request to create the PIN element profile, a request to create the PIN profile, a request to modify the PIN profile, a request to modify the PIN element profile, a request to delete the PIN element profile, a request to delete the PIN profile.

According to an embodiment, the PIN profile may include at least one of a PIN identifier, a PIN name, a maximum number of a PIN element that is configured within the PIN, a list of the PIN element, a life time of the PIN element to be associated with the PIN, a service offered by the PIN, a list of PIN elements that act as a PEGC entity (300), a list of PIN elements comprising a validity duration, a list of PIN elements that act as PEMC entity (200), the list of PIN elements comprising a validity duration, a list of PIN elements that act as a relay, a life span of the PIN, a time period of the PIN when the PIN is active, and a geographical area where the PIN is active.

According to an embodiment, the PIN element profile may include at least one of a PIN element identifier, a list of PIN determine whether the PIN element is authorized to join, services offered by the PIN element, whether the PIN element is authorized to act as at least one of a PEGC entity (300), a PEMC entity (200), a relay entity, accessibility of a list of services in the PIN, a list of PIN elements act as a relay, list of PIN elements it can communicate with, determination about whether the PIN element use the PEGC entity (300) to communicate with a 5GC entity, a connection type, a discoverable option, and duration of the PIN element when the PIN element is active or associated with the PIN.

According to an embodiment, the PIN entity may include at least one of a PIN Element with Management Capability (PEMC) entity (200), a PIN Element with Gateway Capability (PEGC) entity (300) and a PIN management server (100).

According to an embodiment, a Personal Internet of Things (IoT) Network (PIN) management system may be provided.

According to an embodiment, the PIN management system may include; a PIN entity.

According to an embodiment, the PIN entity may be configured to create at least one of a PIN element profile and a PIN profile comprising PIN information.

According to an embodiment, the PIN entity may be configured to store at least one of the PIN element profile and the PIN profile at the PIN entity.

According to an embodiment, the PIN entity may be configured to access at least one of the PIN element profile and the PIN profile.

According to an embodiment, the PIN entity may be configured to perform at least one of activate a PIN, deactivate the PIN, update PIN dynamic information, and manage the PIN profile, where the PIN entity comprises at least one of a PIN Element with Management Capability (PEMC) entity (200), a PIN Element with Gateway Capability (PEGC) entity (300) and a PIN management server (100).

According to an embodiment, a PIN management server (100) may be provided.

According to an embodiment, the PIN management server may include: a processor (110); a memory (130); and a PIN management controller (140), coupled to the processor (110) and the memory (130).

According to an embodiment, the PIN management controller (140) may be configured to receive a request message from a first PINE (400a) from a plurality of PINEs for registering to the PIN as a PIN Element with Management Capability (PEMC) entity (200).

According to an embodiment, the PIN management controller (140) may be configured to authenticate and authorize the first PINE (400a) as the PEMC entity (200) based on the PIN profile.

According to an embodiment, the PIN management controller (140) may be configured to send a response message to the first PINE (400a), wherein the response message indicates that the first PINE (400a) is authorized as the PEMC entity (200).

According to an embodiment, the PIN management controller (140) may be configured to receive an activation request message from the first PINE (400a) for activating the PIN based on the response message.

According to an embodiment, the PIN management controller (140) may be configured to request a fifth generation core (5GC) entity to activate the PIN based on the activation request message.

According to an embodiment, the PIN management controller (140) may be configured to send a PIN activation success response to the first PINE (400a).

According to an embodiment, the PIN management controller (140) may be configured to update the PIN dynamic information.

FIG. 15 illustrates an electronic device according to an embodiment of the disclosure.

Referring to the FIG. 15, the electronic device 1500 may include a processor 1510, a transceiver 1520 and a memory 1530. However, all of the illustrated components are not essential. The electronic device 1500 may be implemented by more or less components than those illustrated in FIG. 15. In addition, the processor 1510 and the transceiver 1520 and the memory 1530 may be implemented as a single chip according to another embodiment.

The electronic device 1500 may correspond to the PIN management server, PIN entity, and/or other entity and/or a node in a communication system described above.

The aforementioned components will now be described in detail.

The processor 1510 may include one or more processors or other processing devices that control the proposed function, process, and/or method. Operation of the electronic device 1500 may be implemented by the processor 1510.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

The memory 1530 may store the control information or the data included in a signal obtained by the electronic device 1500. The memory 1530 may be connected to the processor 1510 and store at least one instruction or a protocol or a parameter for the proposed function, process, and/or method. The memory 1530 may include read-only memory (ROM) and/or random access memory (RAM) and/or hard disk and/or CDROM and/or DVD and/or other storage devices.

The various actions, acts, blocks, steps, or the like in the flow charts (S900-S1400) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a node in a communication system, the method comprising:
receiving a request message from a first personal internet of things (PIN) element (PINE) from a plurality of PINEs for registering to a PIN as a PIN element with a management capability (PEMC) entity;
authenticating and authorizing the first PINE as the PEMC entity based on a PIN profile;
sending a response message to the first PINE, wherein the response message indicates that the first PINE is authorized as the PEMC entity;
receiving an activation request message from the first PINE for activating the PIN based on the response message;
requesting a core entity to activate the PIN based on the activation request message;
sending a PIN activation success response to the first PINE; and
updating PIN dynamic information.

2. The method of claim 1, wherein the request message comprises at least one of a PIN identifier (ID), or a PIN element ID,
wherein the activation request message comprises at least one of the PIN ID, the PIN element ID, the PINAPP ID associated with the first PINE, or a duration of the PIN to be in an active state, and
wherein the PIN dynamic information comprises at least one of a PIN state associated with the first PINE, a PIN validity duration associated with the first PINE, the PIN element ID associated with the first PINE or the PINAPP ID associated with the first PINE.

3. The method of claim 1, wherein updating the PIN dynamic information comprises:
updating and maintaining the PIN dynamic information;
receiving a request message from a second PINE from the plurality of PINEs for registering to the PIN as a PIN element with a gateway capability (PEGC) entity, wherein the request message comprises a PIN ID, a PIN element, a PIN APP ID associated with the second PINE and a validity duration associated with the second PINE;
authenticating and authorizing the second PINE as the PEMC entity based on the PIN profile;
sending a response message to the second PINE, wherein the response message indicates that the second PINE is authorized as the PEGC entity;
updating the PIN dynamic information associated with information associated with the PEGC entity, wherein the information comprises at least one of the PINAPP ID, a PIN element ID, a reachability information, and a validity duration associated with the PEGC entity; and
notifying the information associated with the PEGC entity to the PEMC entity.

4. The method of claim 1, further comprising:
receiving a request message from a third PINE from the plurality of PINEs for deactivating the PIN;
authorizing the third PINE as the PEMC entity based on the PIN profile;
sending a response message to the third PINE, wherein the response message indicates the de-activating the PIN;
notifying that the PIN is de-activated;
receiving a response to the deactivation notification message from the PEMC entity; and
sending a request message to the core entity to deactivate the PIN and clean the PIN dynamic information.

5. The method of claim 4, wherein in case that the PIN being de-activated is notified to the a PEGC entity, the response is received from the PEGC entity,
wherein in case that the PIN being de-activated is not notified to the the PEGC entity, the response is received from the PEMC entity, and
wherein the third PINE is identical to the first PINE.

6. The method of claim 1, further comprising:
receiving a PIN profile management request from a user associated with the first PINE;
identifying whether the user is authorized to perform the requested operation, wherein the identification is based on a local configuration present at the node;
sending a response to the authorized user as success after completing a requested operation or failure with a failure reason; and
notifying a PINE from the plurality of PINEs about the changes corresponding to create a PIN element profile, create the PIN profile, modify the PIN profile, modify the PIN element profile, delete the PIN element profile, and delete the PIN profile.

7. The method of claim 6, wherein PIN profile management request comprises at least one of a request to create the PIN element profile, a request to create the PIN profile, a request to modify the PIN profile, a request to modify the PIN element profile, a request to delete the PIN element profile, a request to delete the PIN profile.

8. The method of claim 6, wherein the PIN profile comprises at least one of a PIN identifier, a PIN name, a maximum number of a PIN element that is configured within the PIN, a list of the PIN element, a life time of the PIN element to be associated with the PIN, a service offered by the PIN, a list of PIN elements that act as a PEGC entity, a list of PIN elements comprising a validity duration, a list of PIN elements that act as a PEMC entity, the list of PIN elements comprising a validity duration, a list of PIN elements that act as a relay, a life span of the PIN, a time period of the PIN in case that the PIN is active, or a geographical area where the PIN is active.

9. The method of claim 6, wherein the PIN element profile comprises at least one of a PIN element identifier, a list of PIN determine whether the PIN element is authorized to join, services offered by the PIN element, whether the PIN element is authorized to act as at least one of a PEGC entity, a PEMC entity, a relay entity, accessibility of a list of services in the PIN, a list of PIN elements act as a relay, list of PIN elements it can communicate with, identifying whether the PIN element use the PEGC entity to communicate with a core entity, a connection type, a discoverable option, and duration of the PIN element in case that the PIN element is active or associated with the PIN.

10. A node in a communication system, the node comprising:
a transceiver; and
a processor coupled with the transceiver and configured to:
receive a request message from a first personal internet of things (PIN) element (PINE) from a plurality of PINEs for registering to a PIN as a PIN element with a management capability (PEMC) entity;
authenticate and authorize the first PINE as the PEMC entity based on a PIN profile;
send a response message to the first PINE, wherein the response message indicates that the first PINE is authorized as the PEMC entity;
receive an activation request message from the first PINE for activating the PIN based on the response message;
request a core entity to activate the PIN based on the activation request message;
send a PIN activation success response to the first PINE; and
update PIN dynamic information.

11. The node of claim 10, wherein the request message comprises at least one of a PIN identifier (ID), or a PIN element ID,
wherein the activation request message comprises at least one of the PIN ID, the PIN element ID, the PINAPP ID associated with the first PINE, or a duration of the PIN to be in an active state, and
wherein the PIN dynamic information comprises at least one of a PIN state associated with the first PINE, a PIN validity duration associated with the first PINE, the PIN element ID associated with the first PINE or the PINAPP ID associated with the first PINE.

12. The node of claim 10, wherein the processor is configured to:
update and maintain the PIN dynamic information;
receive a request message from a second PINE from the plurality of PINEs for registering to the PIN as a PIN element with a gateway capability (PEGC) entity, wherein the request message comprises a PIN ID, a PIN element, a PIN APP ID associated with the second PINE and a validity duration associated with the second PINE;
authenticate and authorize the second PINE as the PEMC entity based on the PIN profile;
send a response message to the second PINE, wherein the response message indicates that the second PINE is authorized as the PEGC entity;
update the PIN dynamic information associated with information associated with the PEGC entity, wherein the information comprises at least one of the PINAPP ID, a PIN element ID, a reachability information, and a validity duration associated with the PEGC entity; and
notify the information associated with the PEGC entity to the PEMC entity.

13. The node of claim 10, wherein the processor is configured to:
receive a request message from a third PINE from the plurality of PINEs for deactivating the PIN;
authorize the third PINE as the PEMC entity based on the PIN profile;
send a response message to the third PINE, wherein the response message indicates the de-activating the PIN;
notify that the PIN is de-activated;
receive a response to the deactivation notification message from the PEMC entity; and
send a request message to the core entity to deactivate the PIN and clean the PIN dynamic information.

14. The node of claim 13, wherein in case that the PIN being de-activated is notified to the a PEGC entity, the response is received from the PEGC entity,
wherein in case that the PIN being de-activated is not notified to the the PEGC entity, the response is received from the PEMC entity, and
wherein the third PINE is identical to the first PINE.

15. The node of claim 10, wherein the processor is configured to:
receive a PIN profile management request from a user associated with the first PINE;
identify whether the user is authorized to perform the requested operation, wherein the identification is based on a local configuration present at the node;
send a response to the authorized user as success after completing a requested operation or failure with a failure reason; and
notify a PINE from the plurality of PINEs about the changes corresponding to create a PIN element profile, create the PIN profile, modify the PIN profile, modify the PIN element profile, delete the PIN element profile, and delete the PIN profile.
